(19) United States
(12) Patent Application Publication
(10) Pub. No.: US 2022/0266125 A1
(43) Pub. Date: Aug. 25, 2022

(54) Scratch and Win Business Game Card

(71) Applicant: Fred Wilson, Toronto (CA)

(72) Inventor: Fred Wilson, Toronto (CA)

(21) Appl. No.: 17/674,996

(22) Filed: Feb. 18, 2022

Related U.S. Application Data
(60) Provisional application No. 63/152,255, filed on Feb. 22, 2021.

(51) Int. Cl. A63F 3/06; B42D 15/02; B42D 25/27; G09F 23/10

(52) U.S. Cl. CPC A63F 3/0665; B42D 15/025; B42D 25/27; G09F 23/10

(57) ABSTRACT

The present invention relates to a scratch and win business game card that is comprised of a front surface and a rear surface that are both further comprised of a plurality of panels. At least one panel is further comprised of at least one scratchable game board that has at least one symbol that can be scratched to reveal a winning or non-winning icon. Based on the number of winning or non-winning icon revealed, the user can further win a prize amount. The remaining panels of the scratch and win business game card may further be comprised of a plurality of indicia in the form of a business card that can be torn away from the body of the scratch and win business game card, as well as instructions and rules for playing the game on the scratchable game board, and prize amounts for winning the game.

### CROSS-REFERENCE TO RELATED APPLICATION

The present application claims priority to, and the benefit of, U.S. Provisional Application No. 63/152,255 which was filed on Feb. 22, 2021 and is incorporated herein by reference in its entirety.

### FIELD OF THE INVENTION

The present invention relates generally to the field of promotional items. More specifically, the present invention relates to a scratch and win business game card. A scratchable game board that has at least one symbol that can be scratched to reveal a winning or non-winning icon is provided. Based on the number of winning or non-winning icons revealed, the user can further win a monetary prize amount. The scratch and win business game card may further be comprised of a plurality of indicia in the form of a business card that can be separated from the body of the scratch and win business game card as well as instructions and rules for playing the game on the scratchable game card, as well as prize amounts for winning the game. Accordingly, the present disclosure makes specific reference thereto. Nonetheless, it is to be appreciated that aspects of the present invention are also equally applicable to other like applications, scratch and win business game cards and methods of manufacture.

### BACKGROUND

Businesses may seek to promote and increase customer visitation, sales and loyalty. However, existing promotional items, such as advertisements, fliers, etc., may be uninspiring and therefore ineffective at promoting a business and increasing said business' customer visitation, sales, and loyalty. In addition, prize giveaways are an exceptionally popular and effective method that attracts a large number of people.

Therefore, there exists a long-felt need in the art for an improved promotional concept. There also exists a long-felt need in the art for a scratch and win business game card that can be used by a business to promote the business and increase customer visitation, sales and loyalty. Further, there exists a long-felt need in the art for a scratch and win business game card that can be used by a business to promote the business and increase customer visitation, sales and loyalty, wherein the scratch and win business game card is more exciting and inspiring than existing traditional promotional concepts items.

The subject matter disclosed and claimed herein, in one embodiment thereof, comprises a scratch and win business game card. The scratch and win business game card is comprised of a front surface and a rear surface that are both further comprised of a plurality of panels, and wherein at least one panel is comprised of at least one scratchable game card. The at least one scratchable game board is further comprised of at least one symbol that can be scratched to reveal a winning or non-winning combination. icon. Based on the number of winning or non-winning icons revealed, the user can further win a prize amount. The remaining panels of the scratch and win business game card may further be comprised of a plurality of indicia in the form of a micro perforated business card that can be easily separated from the body of the scratch and win business game card, as well as instructions and rules for playing the game on the scratchable game Card, and prize amounts for winning the game.

Accordingly, the scratch and win business game card of the present invention accomplishes all of the forgoing objectives and provides an improved promotional tool that can be used by a business to promote the business and increase customer visitation, sales, and loyalty. Furthermore, the scratch and win business game card is more exciting and inspiring than existing traditional promotional items. Thus, the scratch and win business game card overcomes the limitations of existing promotional items known in the industry.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scratch and win business game card. The scratch and win business game card is comprised of a front surface and a rear surface that are both further comprised of a plurality of panels, and wherein at least one panel is comprised of at least one scratchable game board. In differing embodiments, the body of the scratch and win business game card is preferably generally rectangular in shape. However, in differing embodiments the body may be any suitable shape as is known in the art such as, but not limited to, square, circular, triangular, polygonal, etc. The body is further preferably manufactured from a paper-based material such as, but not limited to, paper, heavy paper, pasteboard, cover stock, cardboard, card stock, etc.

The front surface is further comprised of at least two (but in one preferred embodiment, at least three panels) panels. The first panel is preferably comprised of at least one indicia that may be in the form of patterns, logos, emblems, images, symbols, designs, letters, words, characters, animals, advertisements, brands, etc., that may relate to the business who is using the scratch and win business game card as a promotional tool. The second panel is further comprised of at least one indicia in the form of at least one scratch-off game card. In differing embodiments, the board may have a plurality of scratch-off symbol that may be positioned in at least one row and/or at least one column. Underneath each symbol is at least one hidden icon. A user can then scratch each symbol to reveal the hidden indica below the surface layer of each symbol and win a prize amount proportional to the amount of winning icon revealed. The second panel and third panel are separated by a micro perforated edge, such that the third panel can be easily separated from the second panel. The third panel is preferably comprised of at least one indicia in the form of a business card of the business using the scratch and win business game card.

The rear surface is further comprised of at least two panels. A first panel is comprised of at least one indicia that may be in the form of patterns, logos, emblems, images, symbols, designs, letters, words, advertisements, brands, advertisements, brands, skill testing question etc. In one embodiment, the indicia may also be in the form of written instructions how the game on the front surface is played. A second panel is merely the backside of the business card of the third panel of the front surface. This can also serve as an appointment reminder card.

Accordingly, the scratch and win business game card of the present invention is particularly advantageous as it provides an improved promotional tool that can be used by a business to promote the business and increase customer visitation, sales and loyalty. Further, the scratch and win business game card is more exciting and inspiring than existing traditional promotional items. Thus, the scratch and win business game card overcomes the limitations of existing promotional items known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of the front surface of the scratch and win business game card of the present invention in accordance with the disclosed architecture;

FIG. 2 illustrates an enhanced view of one potential embodiment of the gameboard of the scratch and win business game card of the present invention in accordance with the disclosed architecture;

FIG. 3 illustrates a rear view of one potential embodiment of the rear surface of the scratch and win business game card of the present invention in accordance with the disclosed architecture; and

FIG. 4 illustrates a flow chart of one potential method of using the scratch and win business game card of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however that the innovation can be practiced without these specific details. In other instances, well-known structures and scratch and win business game cards are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved promotional tool that can be used by a business to promote the business and increase customer visitation, sales and loyalty. Further, there exists a long-felt need in the art for a scratch and win business game card that can be used by a business to promote the business and increase customer visitation, sales, and loyalty, wherein the scratch and win business game card is more exciting and inspiring than existing traditional promotional items.

The present invention, in one exemplary embodiment, is comprised of a scratch and win business game card comprised of a front surface and a rear surface that are both further comprised of a plurality of panels. At least one panel of the front surface is further comprised of at least one scratchable game board. In differing embodiments, the body of the scratch and win business game card is preferably generally rectangular in shape, but may be any shape known in the art, such as, but not limited to, square, circular, triangular, polygonal, etc. The body is further preferably manufactured from a paper-based material such as, but not limited to, heavy paper, cover stock, card stock, etc.

The front surface is further comprised of at least two (but in one preferred embodiment, at least three) panels, wherein the first panel is preferably comprised of at least one indicia that may be in the form of patterns, logos, emblems, images, symbols, designs, letters, words, characters, animals, advertisements, brands, etc., that may relate to the business that is using the scratch and win business game card as a promotional tool. The second panel is further comprised of at least one indicia in the form of at least one scratch-off game card. In differing embodiments, the board may have a plurality of scratch-off symbol that may be positioned in at least one row and/or at least one column. Underneath each symbol is at least one hidden icon. Accordingly, a user can then scratch each symbol to reveal the hidden indica below the surface layer of each symbol and win a prize amount proportional to the amount of winning icon revealed. The second panel and third panel are separated by a micro perforated edge, such that the third panel can be easily separated from the game portion of the second panel. The third panel is preferably comprised of at least one indicia in the form of a business card of the business using the scratch and win business game card.

The rear surface is further comprised of at least two panels. A first panel is comprised of at least one indicia that may be in the form of patterns, logos, emblems, images, symbols, designs, letters, words, characters, animals, advertisements, brands, etc. In one embodiment, the indicia may also be in the form of written instructions regarding how the game on the front surface is played. A second panel is merely the backside of the business card of the third panel of the front surface, but can also be an appointment reminder card.

Accordingly, the scratch and win business game card of the present invention is particularly advantageous as it provides an improved promotional tool that can be used by a business to promote the business and increase customer visitation, sales, and loyalty. Further, the scratch and win business game card is more exciting and inspiring than existing traditional promotional items. Thus, the scratch and win business game card overcomes the limitations of existing promotional items known in the art.

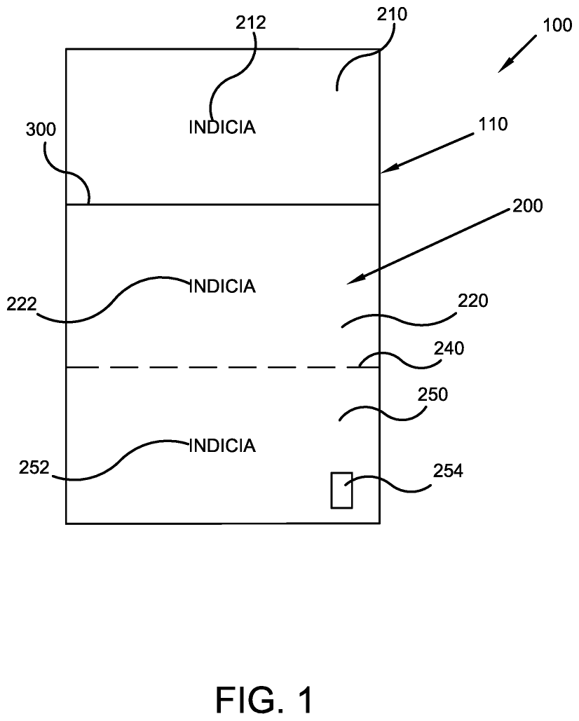

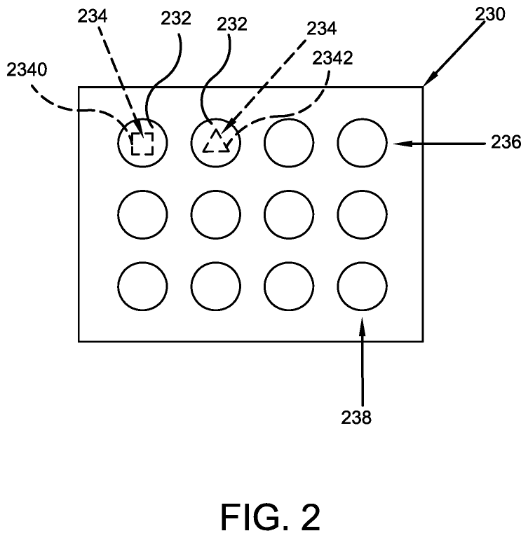

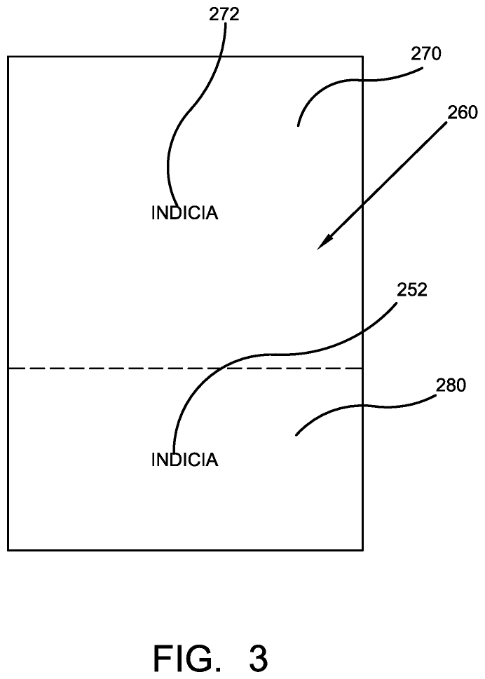

Referring initially to the drawings, FIG. 1 illustrates a front view of one potential embodiment of the scratch and win business game card 100 of the present invention. The scratch and win business game card 100 is comprised of a front surface 200 and a rear surface 260 (shown in FIG. 3) that are both further comprised of a plurality of panels 210, 220, 250, 270, 280, and wherein at least one panel 210, 220, 250, 270, 280, is comprised of at least one scratchable game board 230 (shown in FIG. 2). However, any number of panels can be utilized with the scratch and win business game card 100 depending on the needs and/or wants of a user. Further, the scratch and win business game card 100 can be of any suitable size and shape as is known in the art depending on the needs and/or wants of a user. In differing embodiments, the body 110 of the scratch and win business game card 100 is preferably generally rectangular in shape. However, in differing embodiments the body 110 may be any suitable shape as is known in the art such as, but not limited to, square, circular, triangular, polygonal, etc. The body 110 is further preferably manufactured from a paper-based material such as, but not limited to, paper, heavy paper, pasteboard, cover stock, posterboard, cardboard, card stock, etc., or any other suitable material as is known in the art based on a user's wants and/or needs. The body 110 is further preferably 31.5 in. wide by 7 in. high. The body 110 is further preferably made from black out card or cover stock.

The front surface 200 is further comprised of at least two, but preferably three panels, first panel 210, second panel 220, third panel 250 that in one embodiment may be separated by a border 300. The border 300 can be perforated or cut, etc., allowing the panels 210, 220, 250 to be separated from each other, or the border 300 can be an illustrative border that is folded or marked, etc., allowing the panels 210, 220, 250 to remain connected together. The borders 300 between panels 210, 220, 250 can be either perforated or folded, allowing some of the panels 210, 220, 250 to be separated from each other and some of the panels 210, 220, 250 to remain connected together, depending on the wants and/or needs of a user. Typically, the border 300 between the first panel 210 and the second panel 220 is an illustrative border and allows the first panel 210 and the second panel 220 to remain connected together. Further, the first panel 210 is preferably comprised of at least one indicia 212. The indicia 212 may be any suitable indicia as is known in the art, such as patterns, logos, emblems, images, picture, symbols, designs, letters, words, characters, animals, advertisements, brands, etc., that may relate to the business who is using the scratch and win business game card 100 as a promotional tool.

The second panel 220 is preferably positioned below the first panel 210 but does not have to be, and can be positioned in any suitable position as is known in the art. Accordingly, in differing embodiments all panels 210, 220, 250, 270, 280 may be positioned in any order on the front surface 200 and/or rear surface 260 of the body 110. The second panel 220 is further comprised of at least one indicia 222. Typically, the indicia 222 is in the form of at least one scratch-off game card 230, as shown in FIG. 2. The scratch-off game card 230 can be positioned on any panel 210, 220 or 250, depending on the needs and/or wants of a user, and is not limited to the second panel 220.

The second panel 220 and third panel 250 are separated by a micro-perforated edge 240 (that is preferably 2 in. high), such that the third panel 250 can be torn away from the second panel 220 and removed. However, the edge 240 does not have to be perforated and can be an illustrative border preventing the separation of the second panel 220 from the third panel 250, depending on the needs and/or wants of a user. Further, the third panel 250 is preferably comprised of at least one indicia 252 in the form of a business card a business card, a discount coupon, a free offer, or an invitation of the business using the scratch and win business game card 100, or any other suitable indicia as is known in the art. Said indicia 252 may include, but is not limited to, patterns, logos, emblems, images, symbols, designs, letters, numbers, words, characters, animals, advertisements, brands, maps, addresses, salespeople, managers, owners, promotions, etc. The indicia 252 may also include at least one QR code 254 or other scannable, unique code that can be scanned by a smart scratch and win business game card, wherein the QR code 254 redirects a user to a business's website or other related web page or business information. As a result, once a user has finished playing the game on the game board 230, they can tear off the third panel 250 and retain important business information contained on the third panel 250, while disposing of or redeeming the game board 230. Said indicia 252 and other information on the third panel 250 may also be present on the second panel 280 of the rear surface 260, which is the back of the third panel 250 of the front surface 200 (i.e., the back of the business card displayed on the third panel 250).

FIG. 2 illustrates the game board 230 of the scratch and win business game card 100 of the present invention. The game board 230 may have a plurality of scratch-off symbols 232. The symbol 232 may be any suitable size and shape as is known in the art, or may resemble any object, item, animal, character, etc., known in the art. The symbol 232 can be positioned in any suitable arrangement on the game board 230 as is known in the art depending on the wants and/or needs of a user. However, the symbol 232 are further preferably positioned in at least one row 236. In another embodiment, the symbol 232 may be positioned in at least one row 236 and at least one column 238. Any suitable number of rows and/or columns can be utilized on the game board 230 as is known in the art depending on the needs and/or wants of a user. Underneath each symbol 232 is at least one hidden icon 234. A user can then scratch each symbol 232 to reveal the hidden indica 234 below the surface layer of each symbol 232. The hidden icon 234 may be comprised of “winning icons 2340” and “non-winning icon 2342”. The number of winning icon 2340 revealed by scratching the game board 230 then corresponds to a prize amount. However, one embodiment of the card 100 may have no rows 236 or columns 238, and may have random winning icons 2340 in various mathematical variations. Differing versions of said embodiment may further have differing combinations of guaranteed winning icons 2340.

FIG. 3 illustrates a rear view of one potential embodiment of the rear surface of the scratch and win business game card 100 of the present invention. The rear surface 260 is further comprised of at least two panels 270, 280. Said panels include a first panel 270 and a second panel 280. The first panel 270 is comprised of at least one indicia 272 that may be in the form of patterns, logos, emblems, images, symbols, designs, letters, words, characters, animals, advertisements, brands, etc. In one embodiment, the indicia 272 may also be in the form of written instructions, rules, regulations, and/or prize amounts related to how the game is played. The indicia 272 may also include a skill testing question that allows a user to qualify for a prize such as, but not limited to grand prize or runner up.

For example, the rules of the game for the at least one game board 230 can be as follows. The hidden icon 234 may be comprised of “winning indica 2340” and “non-winning icon 2342”. The number of winning icon 2340 is revealed by scratching the latex or foil game card 230 that corresponds to a prize amount. For example, if each symbol 232 in a row 236 or column 238 (or diagonally through various rows 236 and columns 238) is scratched to reveal a winning icon 2340, then the user wins the maximum prize. If a less than symbol 232 in a row 236 or column 238 (or diagonally through various rows 236 and columns 238) is scratched to reveal a non-winning icon 2342, then a user may still win a proportional (but less) amount of a prize (i.e., runner up).

By way of example, if a game board 230 is comprised of three rows 236 of four symbol 232 and four columns 238 of three symbol 232, scratching and revealing four winning icon 2340 in any row 236, or three winning icon in any column 238, yields a grand prize. Scratching and revealing three winning icon 2340 in any row 236 or two winning icon in any column 238, yields a prize amount less than the grand prize amount. Scratching and revealing two winning icon 2340 in any row 236, or one winning icon in any column 238, yields a prize amount less than the grand prize amount and the amount won if a user revealed three winning icon 2340 in any row 236, or two winning icon in any column 238, etc. In this manner, the fewer winning icon 2340 revealed, the lower the prize amount a user wins. If a user reveals no winning icon 2340 and instead only reveals non-winning icon 2342, the user does not win any prize.

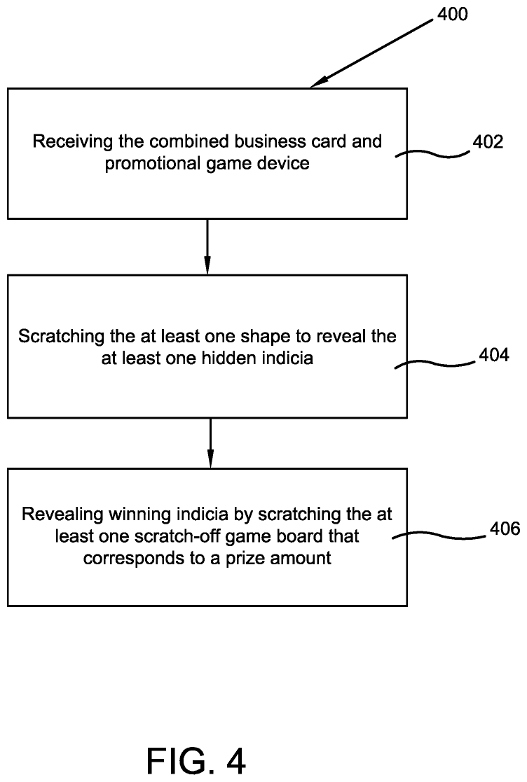

FIG. 4 illustrates a method 400 of promoting a business by using the scratch and win business game card. At 402 a user receives the scratch and win business game card comprised of at least one scratch-off game card, wherein the at least one scratch-off game card comprises at least one symbol and at least one hidden icon. At 404, a user scratches the at least one symbol to reveal the at least one hidden icon, wherein the at least one hidden icon may be comprised of winning indica and non-winning icon. At 406, a user reveals the winning icon by scratching the at least one scratch-off game card that corresponds to a prize amount. For example, a user can scratch and reveal three winning icon in a row of the at least one scratch-off game card, which yields a grand prize amount. Further, a user can scratch and reveal two winning icon in a row of the at least one scratch-off game card which yields a prize amount less than the grand prize. The prize amount can be a monetary amount, a gift card, a coupon, or a reward to a business which is using the scratch and win business game card, or any other suitable prize as is known in the art depending on the wants and/or needs of the user.

It is to be appreciated that in differing embodiments, the scratch and win business game card 100 may have any number of symbol 232, rows 236, columns 238, winning icon 2340 and non-winning icon 2342 in any distribution, position or orientation on the at least one game board 230. As a result, some scratch and win business game cards 100 may be comprised of no winning icon 2340 and some scratch and win business game cards 100 may be comprised of winning icon 2340 or partially-winning icon 2340 (i.e., that would yield less than the grand prize amount). Further, in any embodiment the prize amount may be in the form of money. The amount of money that can be won by the grand-prize and any lower subsequent amounts for various levels of revealing winning icon 2340 may be any dollar amount known in the art. Alternatively, the prize amount may be in the form of gift cards, discount coupons or rewards to the business using the scratch and win business game card 100 as a promotional tool. Further, a user need only reveal one winning icon 2340 to win a prize amount.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “scratch and win business game card” and “scratch and win business game card” are interchangeable and refer to the scratch and win business game card 100 of the present invention.

Notwithstanding the forgoing, the scratch and win business game card 100 of the present invention and its various components can be of any suitable size and configuration as is known in the art without affecting the overall concept of the invention, provided that they accomplish the above-stated objectives. One of ordinary skill in the art will appreciate that the size, configuration and material of the scratch and win business game card 100 as shown in FIGS. 1-3 is for illustrative purposes only, and that many other sizes and shapes of the scratch and win business game card 100 are well within the scope of the present disclosure. Although the dimensions of the scratch and win business game card 100 are important design parameters for user convenience, the scratch and win business game card 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scratch and win business game card comprising:
a body having a front surface and a rear surface;
wherein the front surface comprises a first panel having at least one indicia and a second panel having at least one scratch-off game card; and
wherein the rear surface comprises a first portion and a second portion, wherein each of the first and second portions comprise at least one indicia.

2. The scratch and win business game card of claim 1, wherein the at least one scratch off game board is comprised of at least one symbol and at least one hidden icon that can be revealed by scratching off the at least one symbol.

3. The scratch and win business game card of claim 1, wherein the at least one indicia on the front surface is a pattern, a logo, an emblem, an image, a symbol, a design, a letter, a word, a character, an animal, an advertisement or a brand.

4. The scratch and win business game card of claim 3, wherein the at least one indicia on the front surface relates to a business that is using the scratch and win business game card as a promotional item.

5. The scratch and win business game card of claim 1, wherein the at least one indicia of the first portion of the rear surface is a set of written instructions on how to play the at least one scratch-off game panel or skill testing question.

6. A method of promoting a business by using a scratch and win business game card, the method comprising the steps of:
receiving the scratch and win business game card which is comprised of at least one scratch-off game card having at least one symbol and at least one hidden icon;
scratching the at least one symbol to reveal the at least one hidden icon, wherein the at least one hidden icon may be a winning indica or a non-winning icon; and
revealing the winning icon by scratching the at least one scratch-off game card that corresponds to a prize amount.

7. The method of claim 6 further comprising the step of scratching and revealing a plurality of winning icons in a row and/or column of the at least one scratch-off game card which yields a grand prize amount.

8. The method of claim 7 further comprising the step of scratching and revealing a pair of winning icon in a row or column of the at least one scratch-off game card which yields a prize amount less than the grand prize amount.

9. A scratch and win business game card comprising:
of body further having a front surface and a rear surface;
wherein the front surface comprises a first panel having at least one indicia, a second panel having at least one scratch-off game card comprised of at least one symbol and at least one hidden icon that can be revealed by scratching the at least one symbol, and a third panel further having at least one indica; and
wherein the rear surface comprises a first portion and a second portion, wherein each of the first and second portions comprise at least one indicia.

10. The scratch and win business game card of claim 9, wherein the at least one hidden icon is a winning icon for the at least one scratch-off game card.

11. The scratch and win business game card of claim 9, wherein the at least one hidden icon is a non-winning icon for the at least one scratch-off game card.

12. The scratch and win business game card of claim 9, wherein the second panel of the front surface and the third panel of the front surface are separated by a perforated edge, such that the third panel can be torn away from the second panel.

13. The scratch and win business game card of claim 12, wherein the third panel comprises of a business card, a discount coupon, a free offer, or an invitation.

14. The scratch and win business game card of claim 9, wherein the at least one indicia of the first portion of the rear surface comprises written instructions on how the at least one scratch-off game card is played.

15. The scratch and win business game card of claim 10, wherein revealing the at least one winning icon allows a user to win a prize.

16. The scratch and win business game card of claim 15, wherein the prize is at least one of a monetary amount, a gift card, a discount coupon, and a reward to a business using the scratch and win business game card.

17. The scratch and win business game card of claim 11, wherein revealing the non-winning icon does not allow a user to win a prize.

18. The scratch and win business game card of claim 11, wherein the at least one indicia on the front surface is a pattern, a logo, an emblem, an image, a symbol, a picture, a design, a letter, a word, a character, an animal, an advertisement or a brand.

19. The scratch and win business game card of claim 9, wherein the at least one scratch-off game card is comprised of at least one row.

20. The scratch and win business game card of claim 9, wherein the at least one scratch-off game card is comprised of at least one column.
